(19) United States
(12) Patent Application Publication
(10) Pub. No.: US 2008/0103854 A1
(43) Pub. Date: May 1, 2008

(54) Access Control Within a Publish/Subscribe System

(75) Inventors: Florence Adam, Eastleigh (GB); Peter Brian Masters, Chandler's Ford (GB); Andrew James Osborne, Eastleigh (GB); Martin James Rowe, Chandlers Ford (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/923,003

(22) Filed: Oct. 24, 2007

(30) Foreign Application Priority Data
Oct. 27, 2006 (GB) 0621409.2

(51) Int. Cl. G06F 17/30

(52) U.S. Cl. 705/7

(57) ABSTRACT

There is disclosed a method for access control in a publish/subscribe system. Identification information is associated with the client's connection. A request is subsequently received from the client to publish or subscribe to a topic hosted by the system and that request has an identifier associated with it. It is then determined whether the identification information is consistent with the identifier provided with the request. Only if this is true is the request to publish or subscribe granted. In this way it is possible to determine that there is an appropriate level of trust. For example, when a user says that they are person x, the publish/subscribe system has already established that they too believe this to be true.

### FIELD OF THE INVENTION

The present invention relates to the field of data processing and more specifically to a data processing system which distributes messages from suppliers (publishers) of data messages to consumers (subscribers) of such messages.

### BACKGROUND OF THE INVENTION

Publish/subscribe data processing systems have become very popular in recent years as a way of distributing data messages. Publishers are not concerned with where their publications are going, and subscribers are not interested in where the messages they receive have come from. Instead, a message broker typically assures the integrity of the message source, and manages the distribution of the message according to the valid subscriptions registered in the broker.

Publishers and subscribers may also interact with a network of brokers, each one of which propagates subscriptions and forwards publications to other brokers within the network. Therefore, when the term “broker” is used herein it should be taken as encompassing a single broker or multiple brokers working together as a network to act as a single broker.

FIG. 1 illustrates a typical publish/subscribe data processing system according to the prior art. A message broker 15 has an input mechanism 20 which may be, for example, an input queue or a synchronous input node by which messages are input when they are sent by a publisher 5; 10 to the message broker. A published message is fetched from the input mechanism by a controller 40 and processed to determine, amongst other things, to which subscribers 60; 65; 70 the message should be sent.

Message topics typically provide the key to the delivery of messages between publishers and subscribers. The broker attempts to match a topic string on a published message with a list of clients who have subscribed to receive publications including that topic string. A matching engine 30 is provided in the message broker for this very purpose. When the subscriber registers, it must typically specify a means by which it wants to receive messages (which may be a queue or other input mechanism) and a definition of the types of messages that it is interested in. A subscriber can specify that it wishes to receive messages including a topic string such as “employee/salary” and any messages matching that topic string will be identified and forwarded on to the subscriber via an output mechanism 50. (Note, there may be more than one input and output mechanism to and from which messages are received and sent by the message broker.)

Publish/subscribe is intended to be used to receive targeted information (via the use of topic subscriptions). It is known in the prior art to control which users may subscribe and/or publish on a certain topic via the use of Access Control Lists (ACLs). Such a system is exemplified with reference to FIG. 2.

System 80 hosts a topic space 90. Topic space 90 includes a plurality of different topics (e.g. Weather/Region/England/North; Weather/Region/England/South; Weather/Region/Scotland/North; and Weather/Region/scotland/South) to which users can publish and subscribe. As indicated above, each topic may be associated with an ACL 120-123 which defines the access permissions for the particular topic.

Publish/subscribe could also be used to implement remote participants chat rooms for a video conferencing solution. With such a system it may be important to ensure that all comments posted to a chat room are correctly attributed to the right person. It is however a challenge to be able to guarantee that the person sending messages from a remote location is really who they say they are. Merely using an initial authentication mechanism (e.g. a passworded login) as an access control is not enough on its own. This is because once authenticated, anyone could send a message pretending to be somebody else, unless a secure way to handle messages is provided (proper authorisation).

The BBC have implemented interactive messaging boards at bbc.co.uk/communicate and bbc.co.uk/communicate/archive/jamie_oliver/pagel.shtml. They rely on the IRC (Internet Relay Chat) technology, where they have clients connecting (no authentication) to an IRC channel and asking questions. This channel is monitored by a moderator who will pick questions at random to be asked to the ‘famous person’, this question is then answered in the IRC channel that represents the chat on the web page.

Although the moderator may filter out unwanted messages, there is no authentication and no way of knowing who really asked the question.

The current ACL mechanism typically in use in publish/subscribe systems does not unfortunately adequately address the authorisation problem. The difficulty with a system of this nature, is that new users are continuously logging into the conferencing system and current users are periodically leaving the conferencing system. The issue is over identifying users from a dynamic userbase & granting them authorisation for actions. ACLs are statically defined and consequently each one needs to be individually updated. There may be thousands of publishers and subscribers connecting to a conferencing system with each one needing to be individually added and then later removed from appropriate ACLs. Working in this way is simply not scalable. It should however be noted that publish/subscribe is typically not used in this way. Normally there are a large number of reasonably static subscribers with a few publishers. Consequently the use of ACLs in the past has been perfectly adequate. The use of ACLs in a more dynamic publish/subscribe environment means that current ACL mechanisms are not sufficient.

Note, it is known to use publish/subscribe to provide chat facilities and this all works well when client identity is unimportant and ACLs are therefore unnecessary.

### SUMMARY OF THE INVENTION

According to a first aspect a method for access control in a publish/subscribe system, the method comprising: associating identification information a client's connection; receiving a request from the client to publish or subscribe to a topic hosted by the system, the request having an identifier associated therewith; and determining whether the identification information is consistent with the identifier provided with the request; and granting the publish or subscribe request only if there is consistency. Preferably at least one template rule is applied to a request to publish or subscribe to a topic in order to determine whether to grant said request.

In one embodiment identification information is authentication information determined in response to authenticating the client's connection.

In one embodiment, the identifier is received as part of the topic string to which publication or subscription is requested.

In one embodiment, responsive to granting a publish request, the request to a topic including the identifier is published.

In one embodiment, responsive to granting a subscribe request, the client is subscribed to the requested topic.

In one embodiment the identifier may comprise a userid or a token.

In one embodiment, the identifier comprises a token and the token has a type associated therewith. Template rules may be applied from a set of template rules. Only those rules which expect a token of the type associated with the token provided as an identifier are applied.

According to a second aspect, there is provided apparatus for access control in a publish/subscribe system, apparatus comprising: means for associating identification information a client's connection; means for receiving a request from the client to publish or subscribe to a topic hosted by the system, the request having an identifier associated therewith; and means for determining whether the identification information is consistent with the identifier provided with the request; and means for granting the publish or subscribe request only if there is consistency.

The invention may be implemented in computer software.

### BRIEF DESCRIPTION OF THE DRAWINGS

A preferred embodiment of the present invention will now be described, by way of example only, and with reference to the following drawings:

FIG. 1 shows an exemplary publish/subscribe system in accordance with the prior art;

FIG. 2 shows a publish/subscribe topic space in accordance with the prior art;

FIG. 3 illustrates the topic space for a conferencing system in accordance with a preferred embodiment of the present invention; and

FIGS. 4a to 4e and FIGS. 5 and 6 illustrate the componentry and processing of a preferred embodiment of the present invention.

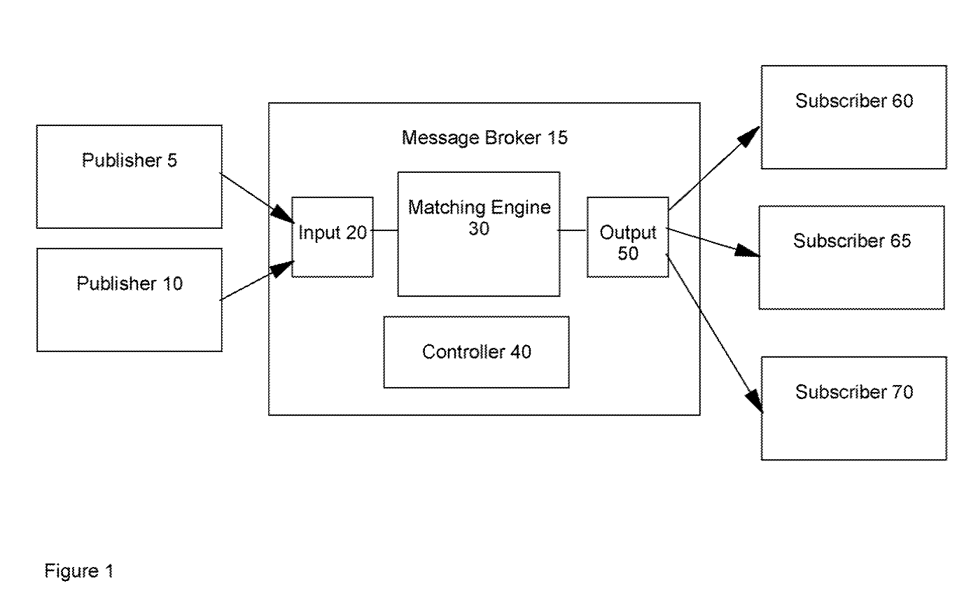

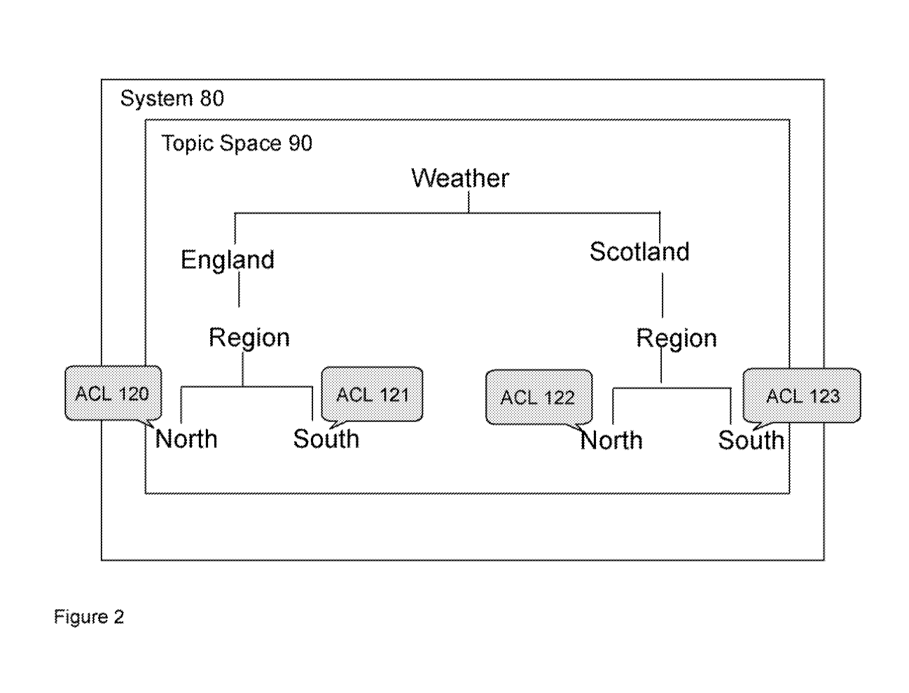

### DETAILED DESCRIPTION

A scalable solution is disclosed which permits the application of appropriate access control to a topic space having a large number of publishers and subscribers which are frequently changing.

A solution is further disclosed which makes it possible to ascertain that messages in a publish/subscribe environment originate from a particular client and not just from any ‘purported’ client. Typically publishers/subscribers in a publish/subscribe environment are unconcerned with client identity. Publishers are not interested to whom their messages are sent and equally subscribers have no interest in from where received messages originate.

In some environments however, client identity is of more importance. The embodiment is described with reference to a conferencing system having virtual chatrooms, however the invention is not limited to such. Rather the invention, in accordance with a preferred embodiment, is applicable to any publish/subscribe implementation having a plurality of dynamic publishers and subscribers where client identity or at least a level of trust is important.

In a conferencing environment, it is important that posts to a chatroom can be verified as having come from the indicated postee. For example, it would be problematic if an impostor purporting to the CIO of a company made detrimental remarks about that company.

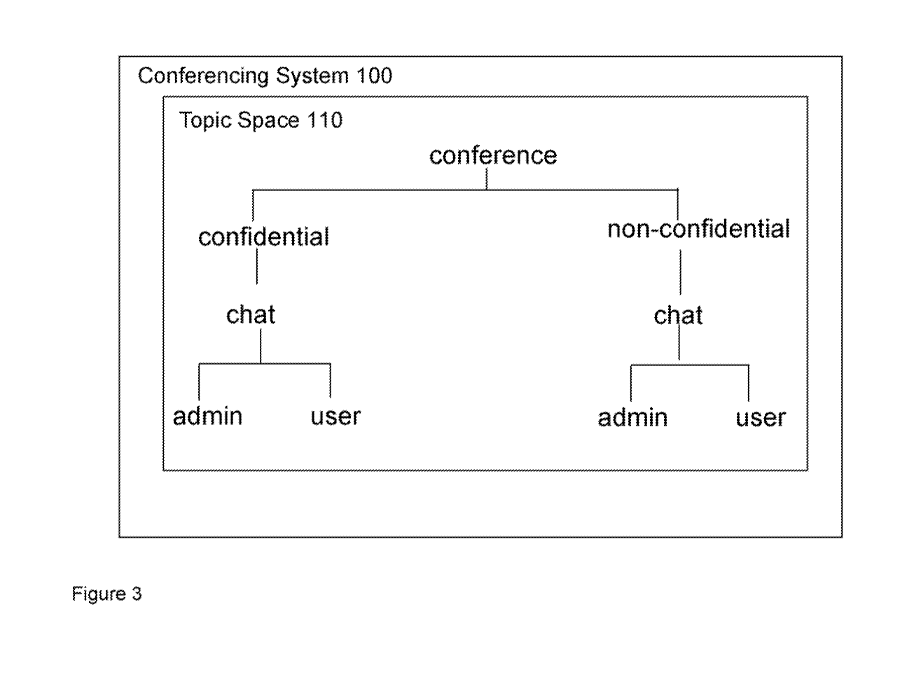

A much simplified exemplary topic space is shown in FIG. 3 for conferencing system 100 implemented using publish/subscribe in accordance with a preferred embodiment of the present invention. Conferencing system 100 hosts topic space 110 which includes a plurality of topics:

conference/confidential/chat/admin

conference/confidential/chat/user

conference/non-confidential/chat/admin

conference/non-confidential/chat/user

Clients make requests to publish on and subscribe to such topics using local client software. This will be discussed in more detail below. Before a client may publish on or subscribe to a topic, they must preferably first have been authenticated to the system.

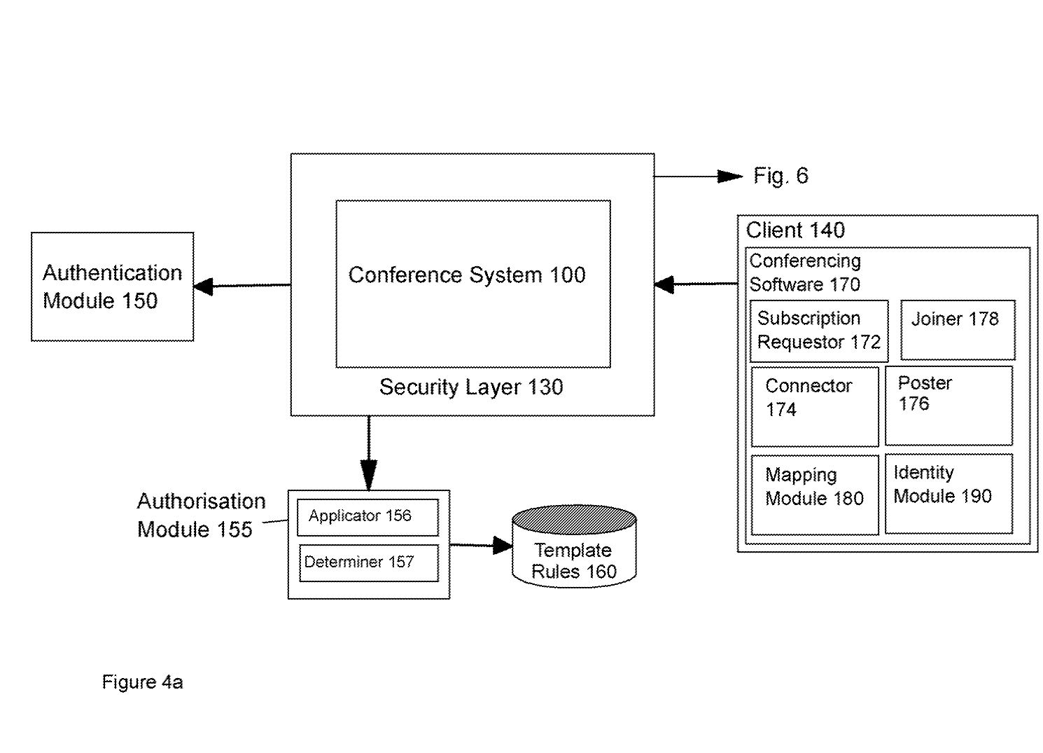

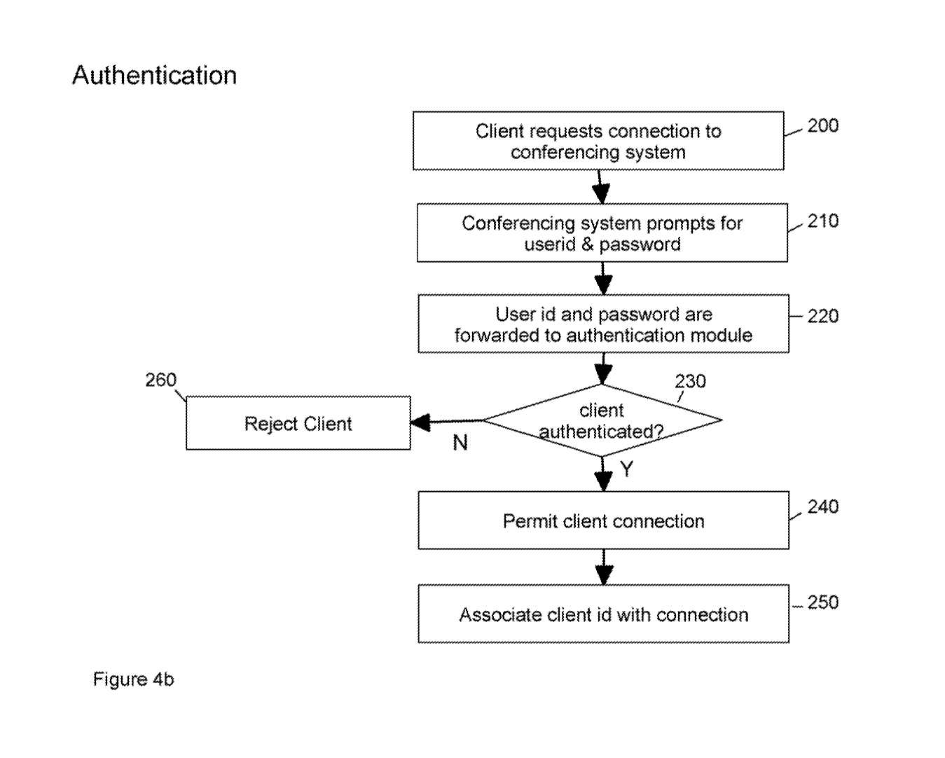

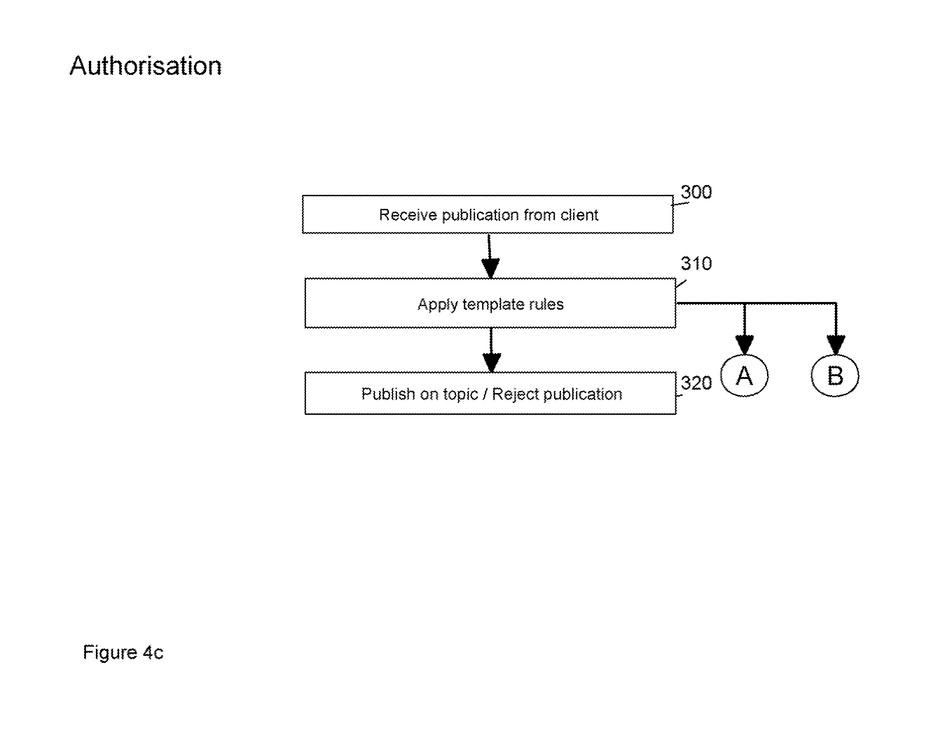

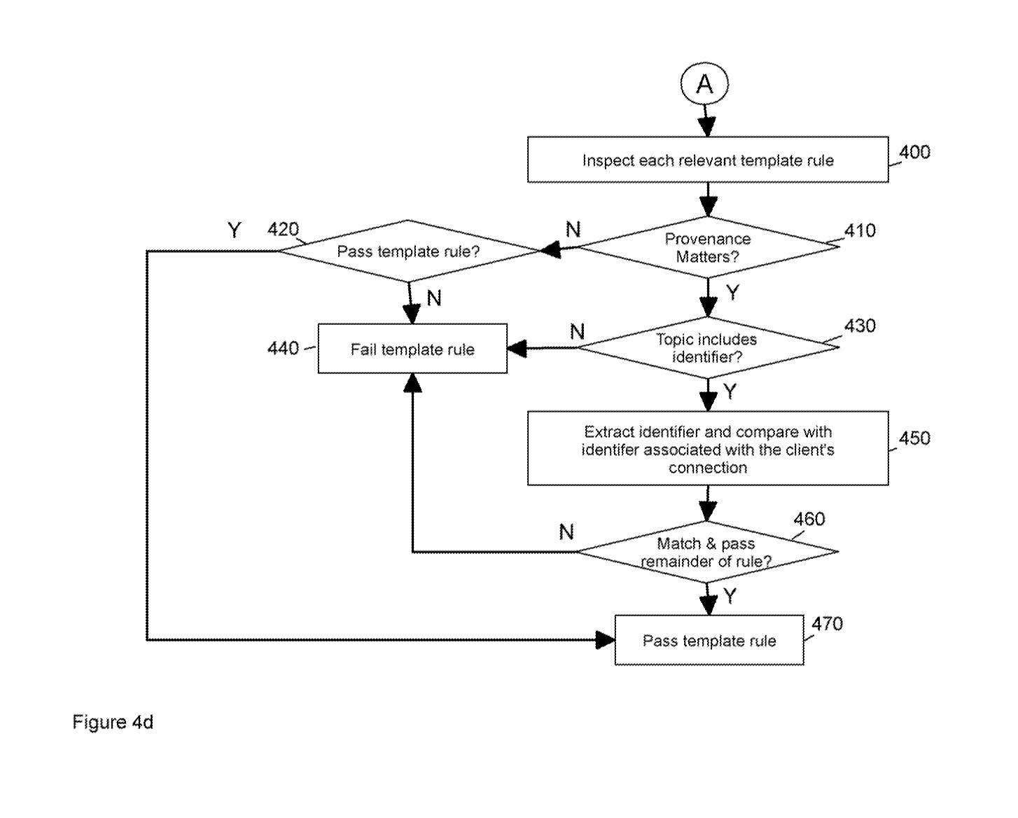

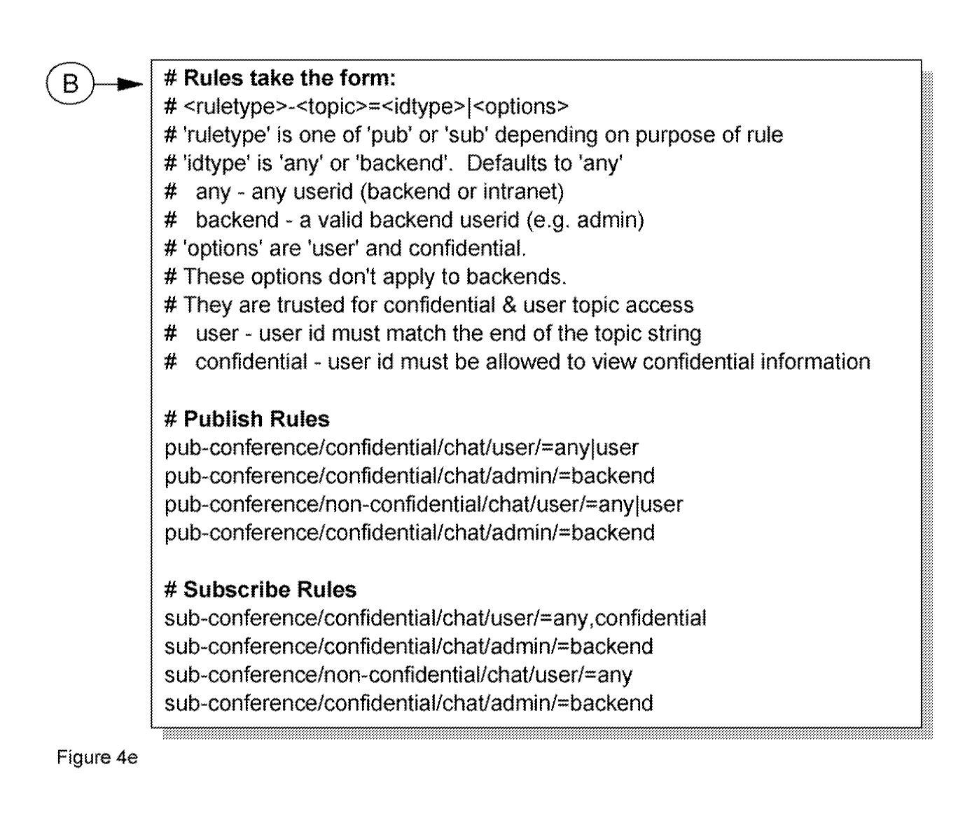

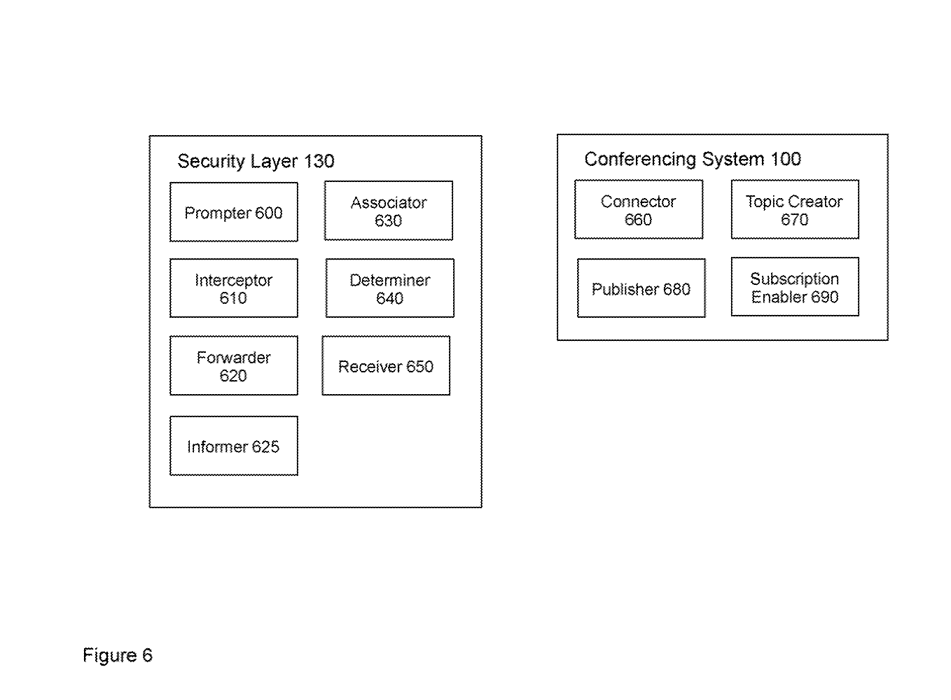

General authentication to the publish/subscribe system described herein is discussed with reference to FIGS. 4a, 4b and 6 which should be read in conjunction with one another.

Conferencing system 100 is enveloped by a security layer 130. Client 140 desires to post a message to the conference or receive information from the conference. Thus via conferencing software 170 (connector 174) a connection is requested (step 200). Security layer 130 intercepts (interceptor 610) the request and prompts (prompter 600) the client for a userid and password (step 210). The userid and password received (receiver 650) from client 140 (connector 174) are then forwarded (forwarder 620) to authentication module 150 (step 220). At step 230 a determination is made by the authentication module 150 as to whether the client is authenticated or not. If not, then the client's connection request is rejected at step 260. Otherwise, the client's connection is permitted (step 240). The client's connector module 174 is informed either way by informer component 625. The client's userid is associated (associator 630) with the client's connection (step 250).

Client 140 now has general access to the conferencing system. Once inside such a system, the client could (without the appropriate measures being in place) now purport to be anyone. Consequently, authorisation processing is subsequently performed before the client is allowed to publish or subscribe to any of the topics hosted by the conferencing system.

Authorisation is discussed with reference to FIGS. 4a to 4e. The figures should be read in conjunction with one another.

As indicated above, client 140 has been authenticated by conferencing system 100 and security layer 130. The client may now attempt to publish and subscribe on the various topics hosted by this system. Publication will be discussed first.

The client uses conferencing software 170 to post messages (poster 176) to various chatrooms within the conferencing system. A client request to post to room x, is then mapped via mapping module 180 to a topic within the conferencing system topic space 110. When the client requests a ‘post’, the client may indicate their ‘purported’ identity to the chatroom.

A publication is received, (receiver 650) from the client 140 at step 300. In the conferencing system of the preferred embodiment, the client is attempting to post to a conference topic. Security layer 130 passes the received publication to authorisation module 155.

Rather than have an Access Control List (ACL) associated with each topic in the topic space, the authorisation module 155 uses (applicator 156) template rules 160. An exemplary set of template rules are shown by FIG. 4e. Application of appropriate template rules (step 310) is discussed below in more detail with reference to FIGS. 4d and 4e. If appropriate template rules are passed, then publication on a topic is permitted, otherwise, publication is rejected (step 320). The client software is preferably not informed when their publication is rejected. As far as the client is concerned, their publication has been accepted. This provides an imposter with little information from which to work out that they have been caught out.

The application of template rules will now be discussed. Each template rule is inspected (step 400). Only relevant rules are fully inspected. In other words, if it is a publish request only publish rules which match the requested topic are fully examined. For each relevant template rule, it is determined whether client provenance is an issue (step 410). FIG. 4e shows exemplary template rules. Rules are of the form: <ruletype>-<topic>=<idtype>|<options>

‘ruletype’ is one of pub (publish) or sub (subscribe) depending on the purpose of the rule;

‘topic’ defines the topic string upon which the publish or subscribe request is being made—e.g. conference/confidential/chat/user (FIG. 3);

‘idtype’ is ‘any’ or ‘backend’—backend is a valid backend userid (e.g. admin)

‘options’ are ‘user’ and ‘confidential’. These options do not apply to backends as they are trusted form confidential and user topic access

‘user’—the provenance of the user matters.

‘confidential’—the userid must be allowed to view confidential information.

Note, whether a user is allowed to review confidential material, is a backend user etc. can be determined using the credentials they provided upon authentication—for example, correlating their credentials with a backend database.

It is determined at step 410 that provenance matters when the template rule currently being inspected includes the ‘user’ option. This will be discussed in more detail shortly.

(Note, step 410 is shown for the sake of explanation only. In reality the rule would be evaluated and certain steps taken if the ‘user’ option is present.)

If it is determined at step 410 that provenance is not an issue, then it is determined at step 420 whether the rule is passed (step 420). This involves looking at the idtype and option(s) specified for each relevant rule. For example, a rule may specify ‘backend’ or ‘any’. If ‘backend’ is specified, then the requestor must be a backend system such as an administrator in order for the rule to be passed. If ‘any’ is specified then an intranet or backend userid is valid. Passing/failure of a rule is shown at steps 440 and 470, respectively.

As indicated above, provenance of a client publishing to, for example, a chatroom may be important. Whilst a user may identify themselves to other chatters in a particular way, it is possible that the user may really be an impostor.

When client 140 attempts to post to a particular chatroom within the conferencing system 100, mapping module 180 (within conferencing software 170), maps the request to a topic string (e.g. conference/confidential/chat/user). Identity module 190 takes this topic string and adds, if appropriate, the userid provided by the client with the post in question. Thus the original topic string may now look as follows: conference/confidential/chat/user/userx@uk.ibm.com.

As an aside, the client preferably knows that to perform a given action within the system (such as publishing a chat message) it must send the message to a given topic, and further preferably knows (through configuration information that it may retrieve from the conferencing system) if that topic requires the userid to be present or not. For every action a client wishes to initiate within the system, the client is aware of the topic that it is required to publish/subscribe on, effectively codifying the set of template rules present within the server. It is acceptable for the client to be aware of this level of knowledge relating actions to topics as it is unable to affect the processing of the rules server side, it may even prove beneficial, as it may prevent enlightened reverse engineering efforts from attempting to forge messages as another userid, since they will see from the action->topic mappings that the restrictions upon the actions may not be enforced within the client code.

When the conferencing software 100 receives a publication from client 140 where provenance matters, additional processing is performed by the authorisation module 155 starting at step 430. It is first determined whether the requested topic string includes a userid added by the identity module 190 (step 430). If it does not, then the template rule is failed. Where the userid is included as part of the topic string, this identifier is extracted and compared with the identifier associated with the particular client's connection to the conferencing system (step 450). The association of an identifier with a client connection was previously discussed with reference to FIG. 4b and happens upon authentication of a client to the conferencing system.

It is determined at step 460 whether the userid associated with the topic string matches the id associated with the client connection, and it is further determined whether the remainder of the rule is fulfilled (step 460). In other words it is determined whether the user that the client is ‘purporting’ to be is truly that user or an impostor, and further whether the request passes any other specified options etc. The outcome of step 460 either results in failure of the template rule (step 440) or passing of the template rule 470.

Although not specifically shown, all relevant rules are inspected and it is determined whether each one is passed or failed. Only if all relevant rules are passed (determiner 157), is publication on the requested topic permitted at step 320 of FIG. 4c. In the preferred embodiment, the message is then published on the topic requested and that topic includes the user's id. This is because publish/subscribe systems do not generally modify messages submitted for publication, so the userid is left as part of the topic that the message is published to. As discussed later, clients wishing to received these messages have the option of including a wildcard where the userid component is expected. In another embodiment, clients are able to embed their own userid, to enable implementation of a request-reply like mechanism, where messages can be targeted to individual clients via the knowledge that only the client with that id will be listening there. The template rule system enforces the privacy of such a request reply system, by ensuring that only authorised publishers can publish a response (typically the backend systems; such backend systems may also perform administrator initiated actions), and that only the matching userid is allowed to subscribe to such. (An example of this usage is a ‘getInitialState’ request reply, used to configure a user joining a talk. They send a message to an initialstate topic with their id inserted into the topic string (as defined by the template rules), and also themselves subscribe to the same topic. The backend server is then able to respond to that unique topic for that user with information intended only for that client).

When it is determined that the requested publication is permitted a unique topic is created (if it doesn't already exist) by the conferencing system (topic creator 670) to allow client 140 to send in messages to participate in the chat. The unique topic is the initial topic string specified by the client and a userid also provided by the user: e.g. conference/confidential/chat/user/userx@uk.ibm.com.

Whilst the solution has been disclosed in terms of a client publishing on a topic including their ‘purported’ identity, this is not the only possibility. In an alternative embodiment, a userid is instead associated with a publication request rather than forming part of the topic string. For a solution where the userid does form part of the topic string, the precise format is not prescribed. The rules template preferably define where the ‘idtype’ sits relative to the ‘topic’.

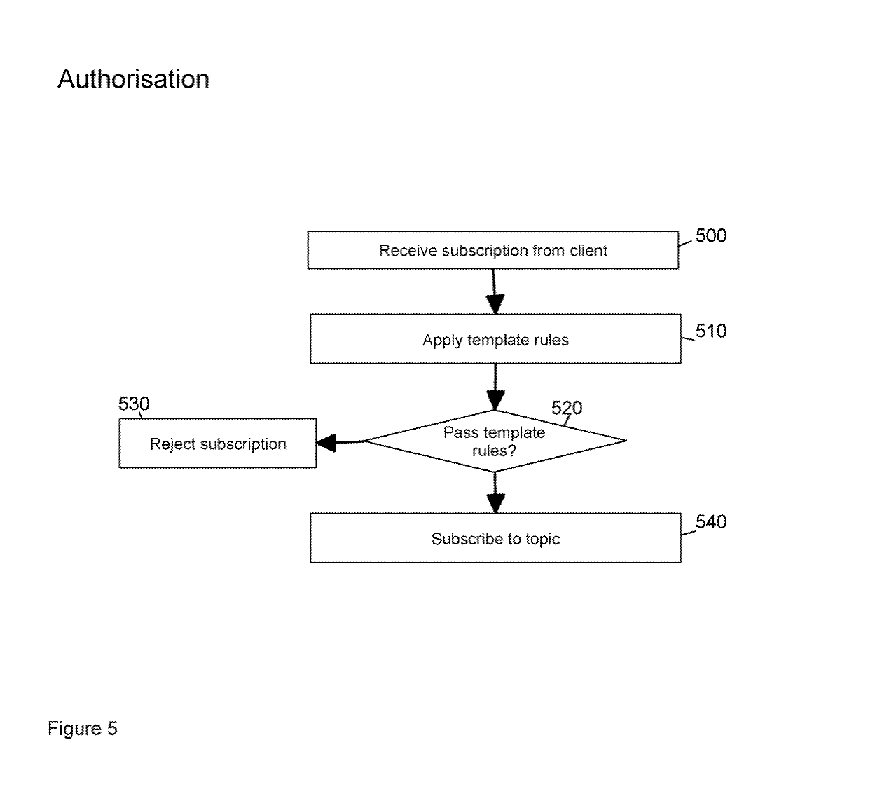

In addition to publication, such a system also accepts subscription requests. When a request is made to join a chat (joiner 178), the mapper component 180 maps the request to an appropriate topic string and the subscription requester 172 then makes the appropriate request. The processing by the security layer 130 of subscription requests is described with reference to FIG. 5.

A subscription request (subscription requestor 172) is received (receiver 650) by the security layer at step 500. As discussed above, each client connected to the conferencing system preferably publishes to their own private and secure sub-topic (i.e. a topic including their userid). Thus it is possible to be sure that that messages published to sub-topics must have been sent by the user they purport to have come from, because only that user has permission to publish to that specific topic.

A subscribing client, preferably subscribes to topics one level up from the private topics which include userids. By way of example, such clients may subscribe to the wildcard topic conference/confidential/chat/#, where # denotes the wildcard. Since such clients are subscribed to the top level chat topic with a wildcard, they will receive all the messages other users are publishing to the chat topic.

Before a client is able to subscribe to a particular topic, that client must be authorised, via the application (applicator 156) of template rules 160, at step 510. It is determined (determiner 157) at step 520 whether appropriate template rules have been passed and only then is the subscription request granted (subscription enabler 690; steps 530, 540). As an optional enhancement to security, the client is not informed when their subscription request is denied.

Messages are preferably displayed in a chat window by the conferencing system software (i.e. client-side):

clientA@xx.ibm.com: [client A's message]

clientB@xx.ibm.com: [client B's message]

The userid component before the colon is taken from the authorised topic that the message was published on. Displayed messages can be viewed by authorised subscribers.

It should be appreciated that whilst private topics have been described herein as relating to single userids, the solution is not limited to such. Userids can be specified as individual users, groups of users or all user. Publishing and subscribing can be restricted based on userid, groups of users or all user.

To summarise, publishing and subscribing to a topic is preferably restricted. Permissions are applied to messages based on configured template rules. Rules can be declared to restrict both publishing and subscribing to individual topics (those without userids) and to topics declared via use of templates. Templates allow definition of topics that contain userids.

The solution described herein is particularly useful in an environment where it is difficult to manage the access control attributed to publishers and/or subscribers. This could be, for example, because the publisher and/or subscribers are dynamic (i.e. frequently changing) and/or because there is a large number of publishers and/or subscribers and specifying permissions individually is time consuming and error prone.

It should be noted that the term “userid” throughout the document should be taken to mean its literal ‘user identifier’, i.e. a means of identifying the authentication used by a given client. It is not limited to its traditionally taken meaning of being ‘a unique identifier of text form assigned to an individual client connection’.

The intent & possibilities of the system are that the id could for instance take the form of a digital certificate for the client, or perhaps the user would authenticate using deferred distributed authentication system (such as ldap, or an intranet password) but then be assigned a “token” which we then expect to be the id to be used where the template rules require. The tokens could then be managed by the system to implement token expiry to provide limited access, or tokens could be shared between users, or groups of users. By way of example, all lawyers could be assigned a lawyer token which could then be used by the template rules to grant access to confidential, non-confidential, and legaladvice topics, where the particular lawyer. That is provided the message is unimportant, provided the clients are able to trust that messages to those topics were in fact issued by someone holding a lawyer token.

The scope & capabilities of such a template system where the id component is some form of token is greatly increased beyond one where the id component is always the traditional ‘userid’.

There is a follow-on/derivative of this that allows for a bag of tokens to be issued to a client as a way of moving some of the processing load from a server to a client. With only 1 token per client, the server is forced to associate the token across multiple functional domains, and assess the membership of the token to any given roles or groups contained within templates, but if multiple tokens are issued to a client, then the client can alleviate some of that work by passing a given token for a given (set of) action(s). This approach lends well to having multiple systems servicing client requests, where each has its own concept over the degree of authorisation required for a given client/action.

To explain the above in more detail, the system functions with each client connection being associated to a token, and the token in turn being used in conjunction with the template rules to provide a mechanism for authorisation for subscription & publication. In the preferred implementation, there is only one token associated to each connection, however it can be advantageous to allow more than one token to be associated to a client connection. When only one token is associated per connection, every potentially matching rule must be evaluated for the given token, to determine if a match has been found. This may result in many attempted matches per attempted publish/subscribe action in order to determine if the action should be allowed. The work involved in evaluating these multiple attempts is performed by a central message broker (e.g. the conferencing system), and may negatively impact the messaging systems performance.

When multiple tokens are associated to a connection, the template rules can be defined to each expect a given token ‘type’. Each token associated to a connection would be categorised, and then upon evaluation, only rules that require a token of a type associated to the current connection would need to be evaluated. (Example Token classification schemes include; making use of a string prefix before a token, making use of information within a digital certificate, the mechanisms for classifying tokens are widespread).

When a client connects, the connection may be authenticated, by evaluating details the client supplies. This evaluation may be performed by a system outside of this invention, the overall outcome is to associate some ‘identification information’ with the connection the client is using. In the case of the conferencing system, the client details is the userid & password, and the resulting identification information is the userid, however, in other implementations you can imagine the client details could be as simple as a secret word, which upon being validated results in assignment of a unique (but anonymous) token for the purposes of the ‘identification information’.

The result is the connection is associated with this identification information, and that for the template based rules, messages published, or received via subscription can be assured to have been validated against these rules. In the case of the conferencing system, this ensures that for the chat message rule, a connection may only publish chat messages for the userid that has been associated to the connection as the identification information. This causes an extension of the trust given by the broker to the client connection, to every message published via a template rule from that connection. The same template rule gives subscribers the ability to trust that received messages were only published by,a client connection with the correct associated identification information. In the case of the exemplary conferencing system, this has the effect of ensuring that a chat message cannot be sent using mismatched user id, and by extension, that any chat messages received must have come from their purported sender. In other implementations, the effect is a basic extension of the trust gained from authenticating the clients credentials, to every receiver of a message from a topic based from a template rule.

In another embodiment, authentication is not required. Instead, a client connection results in the issuance of a token (identification information) which must be consistent with an identifier provided in future requests from the client.

It should therefore be appreciated that identification information does not actually have to identify the client. Rather it is used to ensure that when the client makes a request and includes an identifier, that information is consistent with information associated with their connection. A template rule may specify that an identifier must be included.

It is not necessary that template rules are used to implement a solution which verifies provenance. In another embodiment, every time the client includes identification information (which may be a unique token etc.) in a message, a check may be performed to see whether that information is consistent with information already associated with the client's connection particular connection. Further, the publish/subscribe system may be configured such that provenance is always and issue in which case a check is always performed.

Note, provenance could also be important with respect to a subscription. For example, if a user includes the id to which they want to receive a response, it may be important that this is consistent with their identification details.

Further note, whilst options such as ‘confidential’ may have only been shown with respect to subscribe rules they could equally apply to publish rules or vice versa.

1. A method for access control in a publish/subscribe system, comprising:
associating identification information with a client's connection;
receiving a request from the client to publish or subscribe to a topic hosted by the system, the request having an identifier associated therewith; and
determining whether the identification information is consistent with the identifier provided with the request; and
granting the publish or subscribe request only if there is consistency.

2. The method of claim 1, further comprising:
applying at least one template rule to a request to publish or subscribe to a topic in order to determine whether to grant said request.

3. The method of claim 1, wherein the identification information is authentication information determined in response to authenticating the client's connection.

4. The method of claim 1, wherein the identifier is received as part of the topic string to which publication or subscription is requested.

5. The method of claim 1, further comprising:
responsive to granting a publish request, publishing the request to a topic including the identifier.

6. The method of claim 1, further comprising:
responsive to granting a subscribe request, subscribing the client to the requested topic.

7. The method of claim 1, wherein the identifier comprises a userid or a token.

8. The method of claim 1, wherein the identifier comprises a token and the token has a type associated therewith, the method further comprising:
applying template rules from a set of template rules, the applied template rules being those that expect a token of the type associated with the token provided as an identifier.

9. Apparatus for access control in a publish/subscribe system, apparatus comprising:
means for associating identification information with a client's connection;
means for receiving a request from the client to publish or subscribe to a topic hosted by the system, the request having an identifier associated therewith; and
means for determining whether the identification information is consistent with the identifier provided with the request; and
means for granting the publish or subscribe request only if there is consistency.

10. The apparatus of claim 9, further comprising:
means for applying at least one template rule to a request to publish or subscribe to a topic in order to determine whether to grant said request.

11. The apparatus of claim 9, wherein the identification information is authentication information determined in response to authenticating the client's connection.

12. The apparatus of claim 9, wherein the identifier is received as part of the topic string to which publication or subscription is requested.

13. The apparatus of claim 9, further comprising:
means, responsive to granting a publish request, for publishing the request to a topic including the identifier.

14. The apparatus of claim 9, further comprising:
means, responsive to granting a subscribe request, for subscribing the client to the requested topic.

15. The apparatus of claim 9, wherein the identifier comprises a userid or a token.

16. The apparatus of claim 9, wherein the identifier comprises a token and the token has a type associated therewith, the apparatus further comprising:
means for applying template rules from a set of template rules, the applied template rules being those that expect a token of the type associated with the token provided as an identifier.

17. A computer usable medium embodying computer program code, the computer program code comprising computer executable instructions configured for:
associating identification information with a client's connection;
receiving a request from the client to publish or subscribe to a topic hosted by the system, the request having an identifier associated therewith; and
determining whether the identification information is consistent with the identifier provided with the request; and
granting the publish or subscribe request only if there is consistency.

18. The computer-usable medium of claim 17, wherein the embodied computer program code further comprises computer executable instructions configured for:
applying at least one template rule to a request to publish or subscribe to a topic in order to determine whether to grant said request.

19. The computer-usable medium of claim 17, wherein the identification information is authentication information determined in response to authenticating the client's connection.

20. The computer-usable medium of claim 17, wherein the identifier is received as part of the topic string to which publication or subscription is requested.
